(19) United States
(12) Patent Application Publication
(10) Pub. No.: US 2003/0022054 A1
(43) Pub. Date: Jan. 30, 2003

(54) Method for preparing electrode-membrane assemblies, resulting assemblies and fuel cells comprising same

(76) Inventors: Didier Marsacq, Savonnieres (FR); Franck Jousse, Tours (FR); Michel Pineri, Montbonnot (FR); Regis Mercier, Irigny (FR)

Correspondence Address: BURNS DOANE SWECKER & MATHIS L L P, POST OFFICE BOX 1404, ALEXANDRIA, VA, 22313-1404, US

(21) Appl. No.: 10/220,068

(22) PCT Filed: Mar. 2, 2001
(86) PCT No.: PCT/FR01/00624

(51) Int. Cl. H01M 4/86; H01M 8/10; H01M 4/88; B05D 5/12

(52) U.S. Cl. 429/40; 429/30; 502/101; 429/42; 429/33; 427/115

(57) ABSTRACT

Preparation process of an assembly comprising at least one electrode with an active face, and a thermostable polymer membrane, in which the following steps are carried out:

a) a thermostable polymer solution is cast onto a support in order to obtain a thermostable polymer solution film; then

b) said thermostable polymer solution film is partially dried by evaporation of the, solvent of said solution;

c) an electrode is placed on the surface of said thermostable polymer solution film, while it is drying and before it has dried completely, with the active face of the electrode against said surface, in order to obtain an assembly comprising a thermostable polymer membrane and said electrode;

d) said assembly obtained during step c) is dried completely; then,

e) the assembly comprising said membrane and the said electrode is removed from the substrate;

Electrode-membrane and electrode-membrane-electrode (EME) units obtained by the process and fuel cell comprising these assemblies.

This invention concerns an electrode-membrane and an electrode-membrane-electrode assembly preparation process and the assemblies thus obtained.

More precisely, these assemblies are electrode-membrane-electrode assemblies, in which the membranes are polymer membranes, ion exchangers, such assemblies being more specifically used in fuel cells, especially low temperature fuel cells which operate, in general, at ambient temperature, of up to around 100° C., such as the proton exchanger membrane fuel cells which operate either with the gaseous couple (H₂/oxygen in the air), known as PEMFC, or with the methanol/oxygen couple in the air, known as DFMC (Direct Methanol Fuel Cell).

Consequently, the invention also concerns a fuel cell device, more precisely the solid electrode type, comprising at least one of the said electrode-membrane-electrode assemblies.

The technical field of the invention may therefore be defined as being that of fuel cells, and more specifically of the solid electrolyte type fuel cells.

The solid polymer electrolyte type fuel cells are particularly used in electric vehicles, which are currently the subject of numerous development programmes, in order to provide a solution to the pollution caused by vehicles with thermal engines.

The solid polymer electrolyte fuel cells could allow, by acting as an electrochemical energy converter, connected to an on-board energy tank, for example hydrogen or alcohol, to overcome the problems, in particular those of the recharge time and autonomy, associated with the use of batteries in electric vehicles.

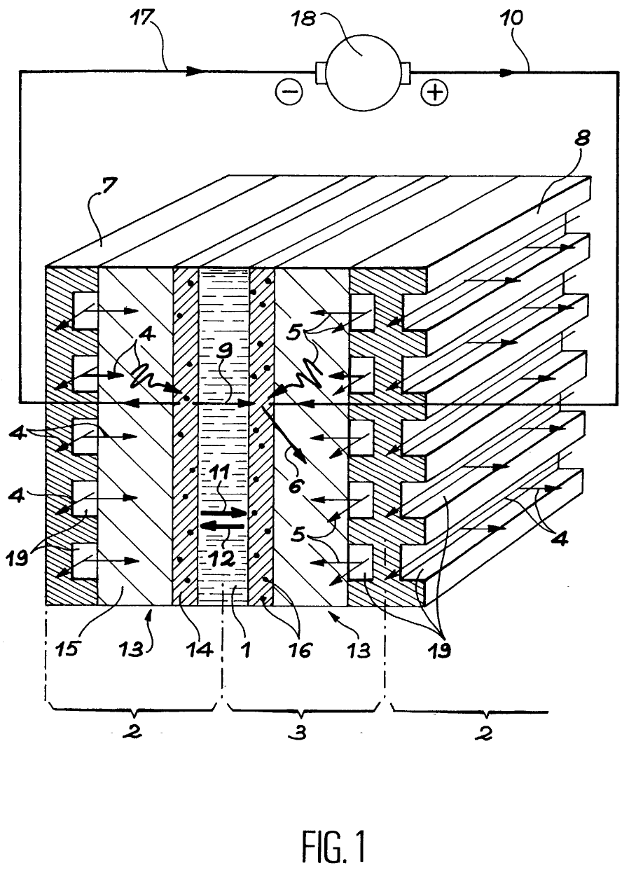

The schematic assembly of a fuel cell, permitting electrical energy to be produced, is partially shown in FIG. 1 attached.

The essential element of such a cell is an ion exchanger type membrane, more precisely a proton exchanger membrane, formed by a solid polymer electrode, more specifically a proton conductor polymer (1); this membrane is used to separate the anodic compartment (2), where the fuel oxidation takes place, for example hydrogen, H₂ (4), as follows:

2H₂→4H⁺+4e⁻

from the cathodic compartment (3), where the oxidant, for example oxygen from the air O₂ (5) is reduced, as follows:

O₂+4H⁺+4e⁻→2H₂O,

which produces water (6), where the anode and cathode are connected by an external circuit (10). The water thus produced enters the two compartments by electro-osmosis and diffusion (arrows 11 and 12).

The volume electrodes (13), that are electronically conductive and positioned either side of the membrane, in general have an active zone (14), and a diffusing zone (15). The active zone, generally located on one of the electrode surfaces, is composed of a Teflon coated porous felt, loaded with carbon black or porous graphite, covered with a finely divided (e.g. in granulate form) noble metal (16), such as platinum, and a thin deposit of ionic conductive polymer, with, in general, a structure similar to that of the membrane. The diffusing zone (15), is composed of a porous material, for example the same porous Teflon coated felt, loaded with carbon black or the same porous graphite, made hydrophobic by means of the inclusion of a hydrophobic polymer, such as PTFE. Its hydrophobic nature allows the liquid water to be evacuated. The noble metal, such as platinum, located in the active zone, permits either the hydrogen or the methanol at the anode to be oxidised, or to reduce the oxygen at the cathode.

The protons produced at the anode, by oxidation, for example of hydrogen, at the surface of the granules of noble metal, such as platinum, are transported (9) through the membrane to the cathode, where they recombine with the ions produced by the reduction, for example the oxygen from the air to make water (6).

The electrons which are thus produced (17), can be used to power, for example, an electric motor (18), located in the external circuit (10), with water being the only by-product of the reaction.

The membrane and electrode assembly is a very thin assembly, approximately 1 millimetre thick, called an electrode-membrane-electrode (EME) assembly, and each electrode is gas powered from the rear, for example using a grooved plate.

The power densities obtained by this recombination, which are generally of around 0.5 to 2 W/cm², in the case of hydrogen and oxygen being used, require several of these volume electrode-membrane-volume electrode assemblies to be combined in order to obtain, for example, the 50 kW necessary for a standard electric vehicle.

In other words, it is important to assemble a large number of these structures, the surface area of their elements measuring approximately 20×20 cm², in order to obtain the desired power, especially in the case where the fuel cell is used in an electric vehicle.

To this end, each assembly formed by two electrodes and a membrane, which define a unit cell of the fuel cell, is therefore positioned between two waterproof plates (7, 8), which, on the one hand, distribute the hydrogen, on the anode side and, on the other hand, the oxygen on the cathode side. These plates are called bipolar plates.

The ion conductor membrane is generally an organic membrane containing ionic groups which, in the presence of water, permit the conduction of the protons (9) produced at the anode by the oxidation of the hydrogen.

The thickness of this membrane is between a few dozen and a few hundred microns and results from a compromise between the mechanical resistance and the ohmic drop. This membrane is also used to separate the gases. The chemical and electrochemical resistance of these membranes makes possible, in general, cell operation of more than 1,000 hours.

The polymer which composes the membrane must therefore satisfy several conditions as concerns its mechanical, physico-chemical and electrical properties.

The polymer must first of all be capable of producing thin films, of between 50 and 100 microns, which are both dense and free from defects. Its mechanical properties, shear rupture modulus and ductility, must permit it to remain compatible with the assembly operations, which include, for example, being clamped between two metal frames.

Its properties must be conserved when it passes from the dry to wet state.

The polymer must have good hydrolytic chemical stability and have good resistance values to reduction and oxidation up to 100° C. This stability is measured in terms of the variation of the ionic resistance, and in terms of the variation of the mechanical properties.

Finally, the polymer must have very good ionic conductivity, this conductivity being provided by strong acid groups, such as the phosphoric acids, but above all by sulphonic acids linked to the polymer chain. For this reason, the polymers will generally be defined by their equivalent mass, which is to say by the weight of the polymer in grams by equivalent in acid.

By way of example, the best systems which have been developed to date are capable of supplying a specific power of 1 W cm⁻², which is to say a current density of 2 A cm⁻² for 0.5 Volts.

The most commonly used polymers at present are sulphonated fluoric thermoplastic polymers, whose main straight chain is perfluorated and whose side chain has a sulphonic acid group.

These thermoplastic copolymers are available in retail sale under the registered brand NAFION® by Du Pont, or ACIPLEX-S® by DOW for the fabrication of the membrane called “XUS”.

We have seen that the electrochemical reactions described by the operations described above, bring into action protons from the electron membrane, the catalyser situated on one of the surfaces of the electrode and finally either the reducer, such as hydrogen, or the oxidant, such as the oxygen in the air, these reactions occurring principally at the edge or the interface between the membrane and the electrode.

It is therefore clear that the performances of an electrode-membrane assembly and therefore of the fuel cell are closely linked to the quality of the electrode-membrane interface, upon which in majority depends the probability of the simultaneous presence in this zone of the different types mentioned above. The manufacturing process of the units or electrode-membrane-electrode assemblies has a decisive influence on the quality of the electrode-membrane interface.

The production of the electrode-membrane-electrode (EME) assemblies is either not or very seldom described in the literature. It concerns in fact more often than not the specific knowledge of each laboratory or industrial company involved in the manufacture of fuel cells.

The EME manufacturing process most often mentioned consists of making the EME assemblies by passing the hot electrodes against the proton exchanger membrane, the said membrane being prepared separately, generally cast and completely dried.

This technique is commonly used in the case of proton exchanger membranes, which are the most commonly used at present and already previously mentioned; which is to say the NAFION® type polymer membranes.

To manufacture the EME assemblies, the electrodes are first impregnated, for example, with a NAFION® solution, and then hot pressed, between 120° and 150° C., on the two faces of the membrane. The thermoplastic nature of NAFION® and the impregnation of the electrodes, with a polymer identical to that which composes the membrane, allow an excellent quality of electrode-membrane interface to be obtained, both in terms of the mechanical properties, represented by excellent adherence, and of the proton-electrode exchange surface.

The electrochemical performances of fuel cells which incorporate such assemblies are therefore satisfactory.

However, this EME assembly manufacturing process has several major drawbacks: firstly, it is difficult to industrialise the process and the NAFION® type polymers are very expensive. Whereas, in the aim of developing fuel cells to be used to power vehicles, another essential problem, identified by experts, is the cost of the membrane, as the latter along with that of the bipolar plates is the preponderant factor which influences the cost of the fuel cell.

In 1995, the cost of the membranes produced or in development was around 3,000 to 3,500 F/m², and it has been estimated that this cost needs to be divided by ten or even twenty in order to justify industrial development of fuel cells for the automobile industry.

In the aim of lowering these costs, sulphonated poly 1.4-(diphenyl-2.6) phenylethers on the main chain, polyethersulphones and polyethercetones have been synthesised and tested without really competing with the fluorated membranes in terms of instantaneous performances and durability.

In order to supply membranes which satisfy the relative conditions, especially as concerns their mechanical, physico-chemical and electrical properties, whilst maintaining a much lower manufacturing cost than the prohibitive cost of the fluorated membranes, described above, new sulphonated polyimide polymers have been developed, which are described in the document reference FR-A-2 748 485.

Whereas, the process described above, is not adapted to the other types of membrane, which is to say membranes that are not made of a thermoplastic polymer such as NAFION®.

In particular, the process used in the example of the NAFION® membranes is completely unsuitable for the membranes composed of a sulphonated polymer with a thermostable skeleton, polymers which include polyimides, polyethersulphones, polyetherethercetones, polybenzoxazoles, polybenzimidazoles, polyphenylenes and their derivatives.

In fact, such membranes possess neither the thermoplastic nature nor the chemical structure of NAFION® and therefore have no attraction for the electrode impregnated with a NAFION® solution and the quality of the electrode-membrane interface is mediocre.

In other words, when a thermostable polymer membrane is used, the process implies the use of several compounds, which is to say a thermostable sulphonated polymer or the proton exchanger membrane, and a NAFION® solution for the impregnation of the electrode.

Furthermore, the process becomes an interrupted complex process which includes several stages, including: creation of the proton exchanger membrane, impregnation of the electrodes, pressing and heating.

The result is that the performances and even the advantages of such assemblies, using a thermostable polymer membrane and a NAFION® type polymer impregnated electrode are extremely limited from an industrial point of view.

If all of the advantages of thermostable sulphonated polymer membranes are to be conserved, in particular in terms of the cost, and the disadvantages mentioned above are to be overcome by improving, in particular, the quality of the electrode-membrane interface, it has been envisaged, in the same way as for the NAFION® type polymer membranes, impregnating the electrodes with a polymer solution which forms the membrane in the case of thermostable skeleton sulphonated polymers, such as polyimides, polyethersulphones, polyetherethercetones, polybenzoxazoles, polybenzimidazoles, polyphenylenes and their derivatives, etc.

However, the mechanical stiffness of this family of polymers causes major mechanical strains to appear at the interfaces during the solvent evaporation drying phase.

In other words, the absence of the thermoplastic nature of these polymers does not allow a satisfactory contact to be established between the membrane and the impregnated electrodes. In this case, the electrochemical performances are not as high and are not as repeatable from one operation to the next. The quality of the interfaces is not sufficient to allow the proton conductor to be brought in close contact with the electronic conductor and the catalyser on the surface of the electrode. This type of assembly is likely to be prone to the effects of ageing and for this to develop quickly in time. In spite of the pressing performed at high temperature, electrode-membrane adherence remains low.

Finally, the numerous stages, already described above, which are part of the manufacture of these assemblies, form an obstacle to large scale production.

In the document U.S. Pat. No. 5,242,764, an assembly process is described which permits the use of a proton exchanger membrane to be avoided. This technique is based on the impregnation of the electrodes, using a large volume of NAFION® solution, followed by hot adherence of the electrodes which have been thus impregnated. This technique is again only suited o NAFION® type thermoplastic polymers, and it makes a gas-impervious, homogenous proton conductive polymer film difficult to obtain.

There is consequently a need for a manufacturing process, for the preparation of assemblies comprising an electrode and a membrane made of a thermostable polymer, also called elementary assemblies, and electrode-membrane-electrode assemblies, that is simple, reliable, repeatable and safe; which only has a limited number of stages, whose cost is reasonable and which can be industrialised, an furthermore this process has all of the inherent advantages of thermostable polymer membranes.

Moreover, this process should allow defect free electrode-membrane interfaces of excellent quality to be obtained, with a very strong electrode-membrane link and very close contact between the catalyser and the membrane, and also these properties would be stable in time and not sensitive to the effects of ageing.

Finally, the electrode-membrane-electrode assemblies obtained must have excellent and perfectly repeatable electrochemical properties.

The aim of this invention is to provide a preparation process for an assembly, including an electrode and at least a thermostable polymer membrane, more specifically a preparation process for an electrode-membrane-electrode assembly, which satisfies, at least, the requirements described above.

The aim of this invention is again to provide a preparation process for an assembly, including an electrode and a thermostable polymer membrane, more specifically a preparation process for an electrode-membrane-electrode (EME) assembly, composed of a thermostable polymer membrane and two electrodes, which does not have the disadvantages, defects, limits and drawbacks of the processes of the prior art and which resolves the problems raised by the prior art.

This aim and others are achieved, in compliance with the invention, by means of a preparation process for an assembly comprising at least one (and preferably one) electrode with one active face, and a thermostable polymer membrane, in which the following steps are followed:

a) a thermostable polymer is cast onto a support in order to obtain a thermostable polymer solution film; then

b) the said thermostable polymer solution film is partially dried by evaporation of the solvent of the said solution;

c) an electrode is placed on the surface of the said thermostable polymer solution film, while it is drying and before it has dried completely, with the active face of the electrode against the said surface, in order to obtain an assembly comprising a thermostable polymer electrode and the said electrode;

d) the said assembly obtained during step c) is dried completely; then,

e) the assembly comprising the said membrane and the said membrane is removed from the substrate.

The process according to the invention allows the requirements to be satisfied and the disadvantages mentioned above to be overcome.

The process according to the invention is particularly suited to thermostable polymer membranes, whose advantages, inherent to this type of polymer, are also passed onto the process which uses them.

The process according to the invention has a limited number of steps, which are simple and easy to carry out using tested equipment. It is reliable and repeatable, can be performed at low temperature, without a high consumption of energy, which is relatively short and only uses few raw materials, limited to the polymer, solvent and electrode.

In contrast to the processes of the previous prior art, it permits industrialised production at low cost.

Fundamentally, according to the invention, the electrode-membrane assembly is created when the membrane is created by casting.

According to the invention, in compliance with step c) of the process, the electrode is simply placed directly, without any other operations (e.g. such as pressing or other, as in the prior art), on the surface of the membrane while it is drying, which is to say that the membrane is therefore composed of a thermostable polymer solution film that is still wet and has not completely dried.

Traditionally, it is known that the membrane is prepared by casting the polymer solution onto a substrate or support, in order to obtain a film of the polymer solution, in particular a thermostable polymer, and this polymer solution film is then dried by complete evaporation of the solvent, and the dry extract obtained forms the membrane, such as the proton exchanger membrane.

In the manufacturing processes of the electrode-membrane assemblies and EME assemblies in the prior art, such as the hot pressing processes, the operation assembly aimed at creating the assembly and creating a connection between the electrode(s) and the membrane is, in all cases, performed with a membrane whose manufacturing process has been completed and that is completely dry. It is therefore a membrane which is entirely and totally formed and dry that is used in the processes of the prior art.

According to the invention, we will proceed inversely to this logic, that is applied and followed systematically in the prior art, by using, during the preparation, a membrane assembly that is being formed, which is to say not completely formed, still wet and not completely dry. In the essential step c) of the invention process, during the drying process, and when the viscosity of the polymer solution film is at an optimum value, an electrode is carefully placed on the surface of the film.

A clearly defined fraction of the polymer solution then impregnates the electrode, and more precisely, the active layer located on its active face which is against the surface of the polymer solution film. This impregnation takes place simply by the action of the weight of the electrode in the polymer, which is still viscous and therefore no pressure needs to be applied.

Thanks to the process of the invention and more specifically its step c), the electrode-membrane interface is of excellent quality. It is very surprising that an interface of this quality can be obtained using thermostable polymer membranes; such a result, which until now was only obtained using NAFION® type thermoplastic polymers, is achieved for the first time by using the process of the invention. It has been shown that the electrode-membrane interface prepared using the process of the invention is perfectly regular and free from defects.

The strength of the bond between the electrode and the membrane is such that they cannot be separated, in contrast to the assemblies created using the processes of the prior art. This excellent bond is, amongst others, one of the fundamental effects and advantages provided by the process of the invention, with respect to the processes of the prior art, such as processes based on hot pressing of the electrode(s) onto the membrane.

We can explain that, in the process of the invention, as the depositing operation according to step c) is carried out when the membrane has not dried or been formed completely, then this means more precisely that the substance which impregnates the electrode is composed of a thermostable polymer, more specifically a proton conductive polymer, and a slight fraction of solvent. This allows the proton conductor to be included homogeneously within the active layer of the electrode itself. The assembly which is thus obtained is then dried in precise conditions at a moderate temperature, in general between 70° C. and 150° C., preferably at a temperature of between 100° C. and 120° C. An example of an adequate temperature is particularly close to 70° C. This favours the presence of the proton conductor polymer close to the electronic conductor and the catalyser contained in the electrode.

In other terms, thanks to the quality of the interfaces obtained by the invention process, there is a close contact between the membrane and the electrode(s), which is to say that the proton conductor is in close contact with the electronic conductor and the catalyser on the surface of the electrode. The result is that the assemblies prepared using the invention process have very good and perfectly repeatable electrochemical properties and performances, which is to say, in particular, an evolution of the voltage according to the current density at the least similar to that of the “all NAFION®” assemblies.

In order to improve the mechanical properties of the assemblies according to the invention even further, at the end of step a), a reinforcement can be placed in the thermostable polymer solution film, for example by lamination.

Or alternatively, in the same aim, a reinforcement can be placed on the support or substrate prior to step a) of the invention process.

The invention concerns more precisely an electrode-membrane-electrode assembly preparation process composed of a thermostable polymer membrane and two electrodes.

First of all, this process includes the creation of a first electrode-membrane assembly by the previously described process, then after step e), we continue to the following step f): a thermostable polymer solution is cast onto the face of the assembly formed by the membrane, in order to obtain a thermostable polymer solution film; then steps b) to e) are more or less repeated.

In other terms, the electrode-membrane assembly obtained after step c) is then used as a substrate during a second casting operation, with partial drying, placing of a second electrode and then complete drying.

The steps of this process will therefore be, apart from steps a), b), c), d), e) and f), as follows:

g) said thermostable polymer solution film is partially dried by evaporation of the solvent of the said solution;

h) a second electrode is placed on the surface of said thermostable polymer solution film, while it is drying, and before it has dried completely, with the active face of the second electrode positioned against the surface of the said film, in order to obtain an electrode-thermostable polymer membrane-electrode assembly; then,

i) said electrode-membrane-electrode assembly is then dried completely during step h).

The advantages and effects provided by this process are those that have already been described above, in particular the assemblies with mechanical and electrochemical properties (an evolution of the voltage according to the current density), etc. superior to those of the assemblies obtained using the processes of the prior art.

According to one variation of the process invention, called an “impregnation” process in contrast to the “coating” process, described above, an electrode-membrane-electrode assembly is prepared according to the following steps:

a) a reinforcement is impregnated with a thermostable polymer solution, in order to obtain a self-supporting, reinforced thermostable polymer solution film; then,

b) said self-supporting, reinforced thermostable polymer solution film is partially dried, by evaporation of the solvent of said solution;

c) an electrode is placed on each of the faces of said thermostable polymer solution film, while it is drying, before it has dried completely, with the active face of each of the electrodes against each of the surfaces of said film;

d) said assembly obtained in step c) is dried completely.

According to one particularly advantageous characteristic of the invention process, whether it concerns the coating process or the impregnation process, the process can be carried out continuously, which is not the case of the processes of the prior art.

The invention also concerns the assemblies with at least one membrane and at least one electrode, as well as the electrode-membrane-electrode assemblies likely to be obtained by the above process. We have seen that these assemblies, as they are and due to the excellent and surprising quality of their interface and resulting mechanical (strength of bond, etc.) and electrochemical properties (evolution of the voltage according to the current density), have inherent properties which differentiate them from the assemblies made using the processes of the prior art and which make them superior to the latter.

The invention concerns, furthermore, a fuel cell device comprising at least one electrode-membrane-electrode assembly obtained using the invention process. In the same way, the cells have, as they are, excellent and surprising qualities, both due to the properties of the thermostable membranes and to the properties of the EME assemblies, these properties resulting directly from the application of the invention process.

The invention will now be described in more detail, with reference to the attached diagrams, in which:

FIG. 1 is a schematic diagram of a fuel cell, comprising several elementary cells with an electrode-membrane-electrode assembly, as well as bipolar plates;

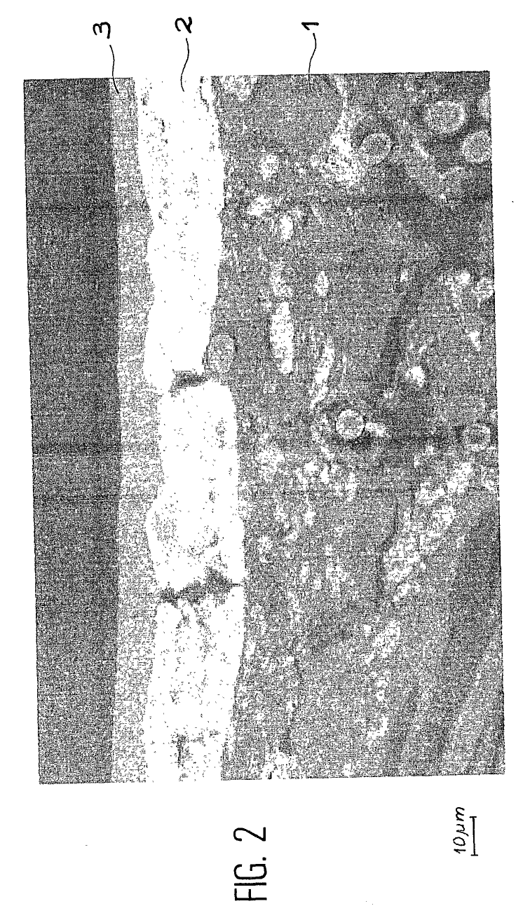

FIG. 2 is an image obtained using a scanning electron microscope of an electrode-membrane interface obtained using the invention process, with a sulphonated polyimide membrane. The scale is 10 μm;

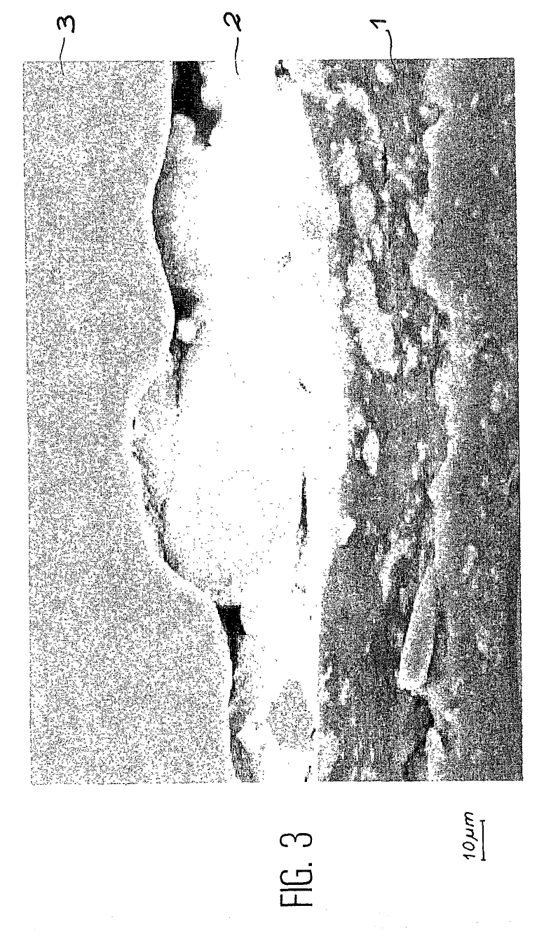

FIG. 3 is an image obtained using a scanning electron microscope of an electrode-membrane interface obtained using a process of the prior art, with a sulphonated polyimide membrane. The scale is 10 μm.

More precisely, the invention process, in its “coating” variation, includes first of all the preparation of a solution, in a solvent, of a thermostable polymer.

The thermostable polymer may be any known polymer. The invention process adapts to any polymer likely to be used to create membranes by casting. By thermostable, it is generally understood a polymer whose vitreous transition (the case of amorphous polymers) or fusion (the case of semi-crystalline polymers) temperature is higher than the polymer's degradation temperature.

In preference, the polymer will be an ion exchanger polymer, and again preferably a proton conductor polymer, such as a sulphonated polymer, but a polymer with phosphate or other functions could also be suitable. Among the adequate polymers, we can name, by way of example, sulphonated polyimides, sulphonated polyethersulphones, sulphonated polystyrenes and their sulphonated derivatives, sulphonated polyetherethercetones and their sulphonated derivatives, sulphonated polybenzoxazoles, sulphonated polybenzimidazoles, sulphonated polyparaphenylenes and their sulphonated derivatives.

The polymers, which are preferred in particular, are the sulphonated polyimides described in the document FR-A-2 748 485 included here by way of reference, especially for the parts of this document which describe these polymers.

Other sulphonated polyimide type polymers are sequenced sulphonated polyimides formed by the blocks or sequences represented by the formulas (Iₓ) and (I_{y}) below:

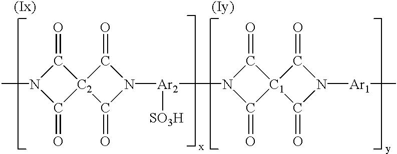

in which:

x is a real number, in preference equal to or greater than 4, and still preferably between 4 and 15; and

y is a real number, in preference equal to or greater than 5, and still preferably between 5 and 10;

and the C₁ and C₂ groups may be identical or different and each represent a tetravalent group including at least one aromatic carbon cycle, which can be substituted, with between 6 and 10 carbon atoms and/or an aromatic nature heterocyclic compound, which can be substituted, with between 5 and 10 atoms and including one or several heteroatoms selected from S, N and O; C₁ and C₂ each forming, with the neighbouring imide groups, cycles of 5 or 6 atoms,

the Ar₁ and Ar₂ groups may be identical, or different and each represent a divalent group including at least one aromatic carbon cycle which can be substituted, with between 6 and 10 carbon atoms and/or an aromatic nature heterocyclic compound, which can be substituted, with between 5 and 10 atoms and including one or several heteroatoms selected from S, N and O; at least one of the said aromatic carbon cycles and/or Ar₂ heterocycles being, moreover, substituted by at least a sulphonic acid group.

Such sulphonated poyimides can be described by the general formula (I):

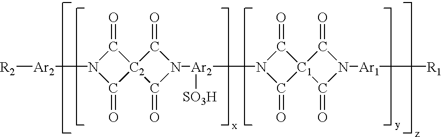

in which C₁, C₂, Ar₁ and Ar₂, x and y have the signification already given above, z is a number, in preference between 1 and 10, and still preferably between 2 and 6, and where each of the R₁ and R₂ groups represent NH₂, or a group of the following formula:

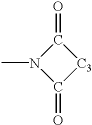

where C₃ is a divalent group including at least one aromatic carbon cycle which can be substituted, with between 6 and 10 carbon atoms and/or an aromatic nature heterocyclic compound, which can be substituted, with between 5 and 10 atoms and including one or several heteroatoms selected from S, N and O, C₃ forming with the neighbouring imide groups, cycles of 5 or 6 atoms.

Most of these polymers can be readily bought and are inexpensive.

The thermostable polymer must also be soluble in the solvent of the solution, this solvent can be easily selected by a man skilled in the art to suit the polymer to be used.

The solvent is generally an organic solvent that is chosen for example from the polar aprotic solvents, such as dimethylformamide (DMF), dimethylacetamide (DMAC), N-methylpyrrolideine (NMP), either alone or mixed with, for example, aromatic solvents such as xylene or glycol ether type solvents.

The solvent may also be a phenolic type solvent, which is to say that it is selected, for example, among phenol, phenols substituted by one or more halogens (Cl, I, Br, F), cresols (o-, m- and p-cresol), cresols substituted by a halogen (Cl, I, Br, F) and their compounds.

The concentration, viscosity and temperature of the polymer solution are adjusted, in order to make it possible to obtain a homogeneous film using the coating system. By way of example, this casting system, is chosen in preference among the Hand Coater systems.

The concentration, viscosity and temperature of the polymer solution applied depend on its nature, but adequate ranges would be, for example, from 30 to 100 g/l, for the concentration, from 1 to 10 Pa.s for the viscosity and from 80 to 130° C. for the temperature of the solution applied by casting (in the case of a sulphonated polyimide type polymer).

This polymer solution is cast onto a substrate or support which can either be flexible or rigid.

By way of example of adequate materials for the substrate or support, we can mention: glass, aluminium, polyester, etc. The shape of this substrate or support is generally the same as that of the membrane and final assembly that is to be prepared. This substrate is generally flat.

Furthermore, it is preferable for the substrate or support to be perfectly clean for the casting operation.

After casting, a film, generally flat, is obtained, of thermostable polymer solution on the surface of the substrate or support, it is a wet “film”, which is to say rich in solvent and containing virtually all of the solvent present in the solution used for casting. The thickness of the wet film varies, but is generally calibrated to a thickness of between 500 and 5,000 μm, for example 3,000 μm.

The partial drying of the polymer solution film is then carried out, by evaporation of the solvent of the said solution. In this aim, the substrate or support is generally maintained at a temperature of between 40° C. and 150° C., for example at a temperature of 120° C., in order to obtain rapid evaporation of the solvent. Such a temperature may be obtained by placing the substrate or support covered with the polymer solution film in a furnace.

The drying operation is partial drying, which is to say that the polymer solution film still contains solvent, and generally the fraction of solvent that is still present is between 5 and 20% of the quantity of solvent that was initially present.

In other terms, the drying process is stopped after a variable duration, generally between 60 and 120 minutes, when the viscosity of the polymer film has reached a level that is high enough to support the electrode. This viscosity can easily be established by an experienced person, but is generally between 20 and 30 Pa.s.

The electrode is therefore placed on the surface of the said thermostable polymer solution film that is drying, before it has dried completely, the active face of the electrode being positioned against the said surface.

The electrode is a classic electrode, that can be readily bought, of the type commonly used in fuel cells and which has already been described above. Such an electrode, generally flat, and of between 100 and 500 μm in thickness, generally has a face called an active face containing the catalyser, for example platinum carbon, it is this active face that is carefully placed on the surface of the wet thermostable polymer solution film.

It slowly impregnates the active layer, for example the platinum carbon layer on the surface of the electrode and the (still wet) membrane-electrode assembly is thus formed.

In the following step, the drying of the electrode-membrane assembly obtained is continued for a duration varying from 30 to 60 minutes, at a temperature of between 70° C. and 150° C., for example at 120° C., in order to eliminate all of the residual solvent still present and to form the final assembly. In fact, it is during this step that the “membrane” is effectively formed.

Finally, in a last step, the electrode-membrane assembly is removed from the substrate or support.

The thickness of such an assembly is between 100 and 500 μm.

When a complete electrode-membrane-electrode assembly is to be formed using the coating process of the invention, first of all a first assembly is prepared, in compliance with the description given above. The electrode-membrane assembly thus obtained is then used as the substrate for a second elementary electrode-membrane assembly, which is to say that another wet film of thermostable polymer solution is cast onto the membrane of the first elementary assembly. It is generally the same solution of the same polymer used to make the first assembly that is used. Then during the drying process of this wet film, a second electrode, generally analogous to the first, is carefully positioned in the conditions described above. Once again, it is the active face of the electrode that is positioned on the surface of the wet film.

The drying process is then completed in the same conditions as those already described for the preparation of the first elementary assembly.

After completion of this process, a complete electrode-membrane-electrode assembly is obtained. It should be noted that this process allows, amongst others, the gas imperviousness of the proton exchanger membrane to be improved.

Advantageously, according to the invention, assemblies can be made in which the membrane is strengthened by a reinforcement in order, in particular, to improve the mechanical properties.

In the coating process, the thermostable polymer solution can be applied and spread onto a substrate or support, as described above, after placing a reinforcement on the said support beforehand.

Such a reinforcement can be composed of a material for example, such as glass, PEEK, PTFE; a post, for example made of glass; a porous material, for example PEEK or PTFE.

The preparation of the solution and all of the other steps of the process and it conditions are analogous to those described above for the coating process, the only difference being that the reinforcement is placed prior to step a) onto the substrate or support.

In other terms, the polymer, for example the sulphonated polyimide used, is in solution in a solvent whose nature can vary, such as phenol, chlorophenol, cresol, NMP, DMF, DMAc, etc. The concentration, viscosity and temperature of the solution are adjusted, in order to make it possible to obtain a homogeneous film using a coating system such as the Hand Coater system.

The polymer solution, for example a sulphonated polymer, is then spread onto a flexible or rigid substrate, for example made of glass, that is perfectly clean and upon which the support is placed. The thickness of the wet film is calibrated to a thickness of between 500 and 5,000 μm, for example around 3,000 μm. The substrate is maintained at a temperature, for example, of around 120° C., in order to cause the solvent to evaporate quickly.

After several minutes (60 to 120), the viscosity of the wet film reaches a level that is high enough to support the electrode. The active face of the electrode containing, for example, platinum carbon, is then carefully placed on the surface of the wet film. It slowly impregnates the active layer, for example the platinum carbon layer on the surface of the electrode. The drying of the electrode-membrane assembly obtained is continued for several minutes more, in order to eliminate all of the residual solvent still present.

The reinforced electrode-membrane assembly is then removed from the initial substrate and is then used, in its turn, as a substrate to carry out a second step.

Another wet film is cast onto the membrane of the first elementary assembly. During the drying process of this wet film, a second electrode, is carefully positioned in the conditions described above.

After completion of these two steps, a complete electrode-membrane-electrode assembly is obtained.

Or alternatively, in the coating process and in the same aim of strengthening the membrane, the reinforcement may be positioned inside the wet polymer solution film prepared by casting during step a). Such a reinforcement is analogous to that described above.

The preparation of the solution and all of the other steps of the process, as well as its conditions, are analogous to those described above for the coating process, the only difference being that the reinforcement is placed inside the wet film itself, after step a). In other terms, the polymer, for example the sulphonated polyimide used, is in solution in a solvent whose nature can vary, such as phenol, chlorophenol, cresol, NMP, DMF, DMAc, etc. The concentration, viscosity and temperature of the solution are adjusted, in order to make it possible to obtain a homogeneous film using a coating system such as the Hand Coater system.

The polymer solution, for example a sulphonated polymer, is then spread onto a flexible or rigid substrate, for example made of glass, that is perfectly clean and upon which the support is placed. The thickness of the wet film is calibrated to a thickness of between 500 and 5,000 μm, for example around 3,000 μm.

The reinforcement is then placed, by any appropriate technique, for example by laminating in the wet film, onto the substrate. The substrate is maintained at a temperature, for example, of around 120° C., in order to cause the solvent to evaporate quickly. After several minutes, the viscosity of the wet film reaches a level that is high enough to support the electrode. The active face of the electrode containing, for example, platinum carbon, is then carefully placed on the surface of the wet film. It then perfectly impregnates the active layer, for example the platinum carbon layer on the surface of the electrode. The drying of the electrode-membrane assembly obtained is continued for several minutes more, in order to eliminate all of the residual solvent still present.

The electrode-membrane assembly is then removed from the substrate and is used to make a reinforced electrode-membrane-electrode assembly, in compliance with the description above.

The process according to the invention, to prepare a complete reinforced electrode-membrane-electrode assembly, can be, according to one variation, carried out by “impregnation”.

A polymer solution is prepared in the same way as described above, the polymers and solvents used for the preparation of this solution are the same as those already mentioned above for the coating process.

The concentration, viscosity and temperature of the polymer solution are adjusted in this case, in order to impregnate the reinforcement, this reinforcement being of the type, already described above, which is to say, for example, a textile, post or porous material for example, such as glass, PEEK or PTFE. For this reason, these concentrations, viscosities and temperatures may differ from those indicated for the coating process.

The concentration, viscosity and temperature of the polymer solution used for the impregnation depend on the nature of the polymer and possibly that of the reinforcement, but adequate ranges would be, for example, from 80 to 120 g/l, for the concentration, from 5 to 15 Pa.s for the viscosity and from 70 to 120° C. for the temperature of the solution which impregnates the reinforcement (in the case of a sulphonated polyimide type polymer).

The impregnation is generally carried out by simply immersing the reinforcement in the polymer solution.

After impregnation, a reinforced, self-supporting thermostable polymer solution film is obtained, this film is a “wet” film, which is to say rich in solvent and containing virtually all of the solvent present in the solution used for the impregnation of the reinforcement. The thickness of the wet polymer film varies, but is generally calibrated to a thickness of between 1,000 and 2,000 μm, for example 1,500 μm.

The partial drying of the reinforced, self-supporting thermostable polymer solution film is then carried out, by evaporation of the solvent of said solution.

In this aim, the reinforced, self-supporting wet film is generally maintained at a temperature of between 70° C. and 150° C., for example at a temperature of 120° C., in order to obtain rapid evaporation of the solvent. Such a temperature may be obtained by placing the reinforced, self-supporting wet film in a furnace.

The drying operation is partial drying, which is to say that the reinforced, self-supporting polymer solution film still contains solvent, and generally the fraction of solvent that is still present is between 5 and 15% of the quantity of solvent that was initially present.

In other terms, the drying process is stopped after a variable duration, generally between 60 and 120 minutes, when the viscosity of the reinforced, self-supporting polymer film has reached a level that is high enough to support the electrodes on either side. This viscosity, which may be different from that, during the same step of the coating process, can easily be established by an experienced person, but is generally between 15 and 20 Pa.s.

The electrodes are therefore placed on the surface of the said reinforced, self-supporting wet thermostable polymer solution film that is drying, before it has dried completely, the active face of each of the electrodes being positioned against each of the said surfaces.

This operation is performed by a “co-laminating” device.

The electrodes are classic electrodes, of the type commonly used in fuel cells and which have already been described above. These electrodes, generally have a face called an active face containing the catalyser, for example platinum carbon, it is this active face of each of the electrodes that is carefully placed on each of the surfaces of the reinforced, self-supporting wet thermostable polymer solution film.

It slowly impregnates the active layer, for example the platinum carbon layers on the surface of the electrodes and forms directly the electrode-(still wet) membrane-electrode assembly.

In the following step, the drying of the electrode-membrane assembly obtained is continued for a duration varying from 30 to 60 minutes, at a temperature of between 70° C. and 150° C., for example at 120° C., in order to eliminate all of the residual solvent still present and to form the final EME assembly. In fact, it is during this step that the “membrane” is effectively formed.

This process allows a complete assembly to be obtained in two simple steps.

The EME assemblies, prepared according to the invention, can be used, in particular, in a fuel cell that can operate, for example, with the following systems:

hydrogen, alcohols, such as methanol, at the anode;

oxygen, air at the cathode.

This invention also covers a fuel cell comprising at least one EME assembly prepared using the invention process.

Such a cell has all of the properties related to thermostable membranes: for example, thanks to its excellent mechanical properties, the membrane can withstand strains (clamping, etc.) related to the assembly of such a device without suffering any damage.

The properties of the sulphonated polymide type thermostable membranes are, for example, described in the document FR-A-2 748 485, already mentioned.

The fuel cell may, for example, correspond to the layout already given in FIG. 1.

Such a fuel cell, in which the EME assembly(ies) is/are prepared using the process of this invention, consequently has, for this reason, all of the advantages related to these assemblies and the excellent quality of their interface: in particular, excellent robust assemblies, reliability, excellent mechanical and electrochemical properties (evolution of the voltage according to the current density, at the least similar to that of the “all NAFION®” assemblies), gas imperviousness, etc. and all of these properties are perfectly repeatable and do not diminish in time.

These properties are significantly superior to those of cells comprising assemblies made using the prior art, for example: the cell temperature is generally maintained at between 50° C. and 80° C. and, in these conditions, it produces for example a current density of 0.5 A/cm² with a voltage of 0.6 V, and for a very long period of up to 3,000 hours, which demonstrates excellent properties in terms of thermal and mechanical stability as well as those of the assemblies and excellent electrical properties.

The invention will now be described with reference to the following examples, that are given by way of illustration and are in no way restrictive:

### EXAMPLES

### Example 1

Manufacture of an Electrode-Membrane Assembly Using the Invention Process

This concerns the manufacture of an electrode-membrane assembly in sulphonated polyimide, whose molecular structure is described below:

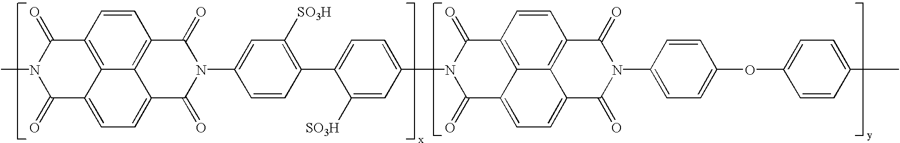

The values of x are generally from 0≦x, y≦20; and for example in this particular case x=8 and y=10.

The sulphonated polyimide used is in solution in metacresol. The concentration, viscosity and temperature of the solution are adjusted, in order to make it possible to obtain a homogeneous film using the Hand Coater system, and are as follows:

concentration: 70 g/l;

viscosity: 4 Pa.s;

temperature: 120° C.

The sulphonated polyimide solution is then spread onto a 3 mm thick, rectangular glass substrate, that is perfectly clean. The thickness of the wet film is calibrated to a thickness of around 3,000 μm. The substrate is maintained at a temperature of around 120° C., in order to cause the solvent to evaporate quickly.

After several minutes, the viscosity of the wet film reaches a level that is high enough to support the electrode. This electrode is an electrode supplied by SORAPEC®.

The face of the electrode containing the platinum carbon is then carefully placed on the surface of the wet film. It slowly impregnates the platinum carbon layer on the surface of the electrode. The drying of the electrode-membrane assembly is continued for another . . . minutes, in order to eliminate all of the residual solvent still present.

The electrode-membrane assembly is then removed from the substrate.

### Example 2

Manufacture of a Complete Electrode-Membrane-Electrode Assembly Using the Coating Process

This concerns the manufacture of an electrode-membrane-electrode assembly in sulphonated polyimide, in two distinct steps:

Step 1

Manufacture of an Elementary Electrode-Membrane Assembly A first electrode-membrane assembly is made in compliance with the description of example 1. The electrode-membrane assembly thus obtained is used as a substrate to carry out the second step.

Step 2

Manufacture of a Second Elementary Electrode-Membrane Assembly

Another wet film is cast onto the membrane of the previous assembly. While this wet film is drying, a second electrode is carefully put into place, in compliance with the description of example 1.

After completion of these two steps, a complete electrode-membrane-electrode assembly is obtained. This operating method also allows the gas imperviousness of the proton exchanger membrane to be improved.

### Example 3

Manufacture of a Complete Electrode-Reinforced Membrane-Electrode Assembly by Coating

The sulphonated polyimide used is the same as above. The concentration, viscosity and temperature of the solution are adjusted, in order to make it possible to obtain a homogeneous film using the Hand Coater system, and are the same as in example 1. The sulphonated polyimide solution is then spread onto a perfectly clean glass substrate, upon which is placed the PEEK material supplied by SEFAR®. The thickness of the wet film is calibrated to a thickness of around 3,000 μm. The substrate is maintained at a temperature of around 120° C., in order to cause the solvent to evaporate quickly. After several minutes, the viscosity of the wet film reaches a level that is high enough to support the electrode, which is to say around 15 Pa.s. The face of the electrode containing the platinum carbon is then carefully placed on the surface of the wet film. It slowly impregnates the platinum carbon layer on the surface of the electrode. The drying of the electrode-membrane assembly is continued for another 60 minutes, in order to eliminate all of the residual solvent still present.

The electrode-reinforced membrane assembly is then removed from the substrate and used as the substrate for the second step.

Another wet film is cast onto the membrane of the previous assembly. While this wet film is drying, a second electrode is carefully put into place, in compliance with the description of example 1.

After completion of these two steps, a complete electrode-membrane-electrode assembly is obtained.

### Example 4

Manufacture of a Complete Electrode-Reinforced Membrane-Electrode Assembly by Coating

This concerns the manufacture of an electrode-membrane-electrode assembly reinforced by PEEK material supplied by SEFAR®.

The sulphonated polyimide used is the same as above, and is in solution in a solvent, the solvent used is metacresol.

The concentration, viscosity and temperature of the solution are adjusted, in order to make it possible to obtain a homogeneous film using the Hand Coater system, and are the same as in example 1. The sulphonated polyimide solution is then spread onto a perfectly clean glass substrate. The thickness of the wet film is calibrated to a thickness of around 3,000 μm.

The reinforcement is then placed in the wet film, on the substrate. Under the action of its own weight, the reinforcement penetrates inside the film until it comes into contact with the substrate. The substrate is maintained at a temperature of around 120° C., in order to cause the solvent to evaporate quickly. After several minutes, the viscosity of the wet film reaches a level that is high enough to support the electrode. The face of the electrode containing the platinum carbon is then carefully placed on the surface of the wet film. It slowly impregnates the platinum carbon layer on the surface of the electrode. The drying of the electrode-membrane assembly is continued for another 60 minutes, in order to eliminate all of the residual solvent still present.

The electrode-membrane assembly is then removed from the substrate and then used to create a reinforced electrode-membrane-electrode assembly in compliance with the description of example 2.

### Example 5

Manufacture of a Complete Reinforced Electrode-Membrane-Electrode Assembly by Impregnation

This concerns the manufacture of a reinforced electrode-membrane-electrode assembly. The sulphonated polyimide used is in solution in a solvent, the solvent used is metacresol. The concentration, viscosity and temperature of the solution are adjusted, in order to make it possible to impregnate the reinforcement, and are as follows:

concentration: 80 g/l;

viscosity: 2 Pa.s;

temperature: 120° C.

The thickness of the reinforced, self-supporting wet film is calibrated to around 3,000 μm.

The reinforced, self-supporting wet film is maintained at a temperature of around 120° C., in order to cause the solvent to evaporate quickly.

After several minutes, the viscosity of the reinforced, self-supporting wet film reaches a high enough level, which is to say 15 Pa.s, to support the electrodes on either side. The face of the electrodes containing the platinum carbon is then carefully placed on the surface of the reinforced, self-supporting wet film. It slowly impregnates the platinum carbon layer on the surface of the electrodes. The drying of the electrode-membrane assembly is continued for several minutes more, in order to eliminate all of the residual solvent still present.

The assemblies obtained in example 1, with the sulphonated polyimide membrane whose structure is described in example 1, are characterised in that the electrode-membrane interface is of very good quality, as shown in FIG. 2. In fact, on this photograph, taken with a scanning electron microscope, the electrode-membrane interface is perfectly regular and free from defects and no homogeneity is visible.

Examining the photograph from the bottom to the top, several levels can be distinguished, which respectively correspond to the core of the electrode (Teflon felt loaded with carbon black, part 1), the layer of platinum carbon (light, shiny level, part 2), which is around 20 μm thick, and finally the proton exchanger membrane (part 3), which is around 15 μm thick.

The bond between the electrode and the membrane is so strong that it is no longer possible to separate them, in contrast to the assemblies produced using the existing processes.

This type of analysis, using a scanning electron microscope, aimed at characterising the electrode-membrane interface permits the assemblies obtained by the invention process to be distinguished from the assemblies obtained from any other processes based on pressing a formed membrane and an electrode.

In fact, all other processes based on the pressing of a formed (dry) membrane and an electrode leads to the formation of defects at the electrode-membrane interface, as shown by FIG. 3, wherein the reference numbers have the same meaning as in FIG. 2.

In FIG. 3, which shows the electrode-membrane interface of an assembly obtained by pressing, according to the prior art, vacuoles and other defects can be clearly distinguished. These defects are at the origin of the poor electrochemical performances of these assemblies.

In fact, apart from the bonding problems, various heterogeneities, such as air vacuoles, fold zones, etc. are visible at the electrode-membrane interface of the assemblies obtained by the traditional processes.

Furthermore, a map of the sulphur element has been made using a casting probe on an assembly obtained using the invention process, according to the description of example 1. In this map, the sulphur element allows the presence of the proton conductor to be identified. It can be clearly seen that the invention process permits a fraction of the proton conductor to be brought into the platinum rich zone.

1. Preparation process of an assembly comprising at least one electrode with an active face, and a thermostable polymer membrane, in which the following steps are carried out:
a) a thermostable polymer solution is cast onto a support in order to obtain a thermostable polymer solution film; then
b) said thermostable polymer solution film is partially dried by evaporation of the solvent of said solution;
c) an electrode is placed on the surface of said thermostable polymer solution film, while it is drying and before it has dried completely, with the active face of the electrode against said surface, in order to obtain an assembly comprising a thermostable polymer electrode and said electrode;
d) said assembly obtained during step c) is dried completely; then,
e) the assembly comprising said membrane and said electrode is removed from the substrate;

2. Process set forth in claim 1, in which, prior to step a), a reinforcement is placed on said support.

3. Preparation process set forth in claim 1, in which, after completion of step a), a reinforcement is placed in the thermostable polymer solution film.

4. Process set forth in claim 3, in which said reinforcement is placed by lamination in the thermostable polymer solution film.

5. Process set forth in any of claims 1 to 4, for the preparation of en electrode-membrane-electrode EME assembly composed of a thermostable polymer membrane and two electrodes and including furthermore, after completion of step e), the following steps:
f) a thermostable polymer solution is cast onto the face of the assembly, by the membrane, in order to obtain a thermostable polymer solution film; then
g) said thermostable polymer solution film is partially dried by evaporation of the solvent of said solution;
h) a second electrode is placed on the surface of said thermostable polymer solution film, while it is drying, before it has dried completely, with the active face of the second electrode against the surface of said film, in order to obtain an electrode-thermostable polymer membrane-electrode assembly; then
i) said electrode-thermostable polymer membrane-electrode assembly obtained during step h) is dried completely; then,

6. Preparation process of an electrode-membrane-electrode (EME) assembly in which the following steps are carried out:
a) a reinforcement is impregnated by a thermostable polymer solution, in order to obtain a self-supporting, reinforced thermostable polymer solution film; then,
b) said self-supporting, reinforced thermostable polymer solution film is partially dried, by evaporation of the solvent of said solution;
c) an electrode is placed on each of the faces of said thermostable polymer solution film, while it is drying, before it has dried completely, with the active face of each of the electrodes against each of the surfaces of said film;
d) said assembly obtained in step c) is dried completely.

7. Process set forth in any of claims 1 to 6, carried out in continuous production.

8. Process set forth in any of claims 1 to 7, in which said thermostable polymer is an ion exchanger polymer, such as a proton conductor polymer.

9. Process set forth in claim 8, in which said polymer is selected from the sulphonated polyimides, sulphonated polyethersulphones, sulphonated polystyrenes and their sulphonated derivatives, sulphonated polyetherethercetones and their sulphonated derivatives, sulphonated polybenzoxazoles, sulphonated polybenzimidazoles, sulphonated polyparaphenylenes and their sulphonated derivatives.

10. Assembly comprising at least one electrode and a membrane obtainable by the process set forth in claims 1 to 4 and 7 to 9.

11. Electrode-membrane-electrode assembly obtainable by the process set forth in any of claims 5 to 9.

12. Fuel cell comprising at least one electrode-membrane-electrode assembly set forth in claim 11.
